(19) United States
(12) Patent Application Publication
(10) Pub. No.: US 2025/0046483 A1
(43) Pub. Date: Feb. 6, 2025

(54) METHOD AND APPARATUS FOR SAFE AND EFFICIENT NUCLEAR POWER GENERATION

(71) Applicant: Muons, Inc., Batavia, IL (US)

(72) Inventor: Rolland Paul Johnson, Newport News, VA (US)

(21) Appl. No.: 18/790,654

(22) Filed: Jul. 31, 2024

Related U.S. Application Data
(60) Provisional application No. 63/516,683, filed on Jul. 31, 2023.

(51) Int. Cl. G21C 19/307; G21C 1/30; G21C 3/60; G21C 19/40; G21C 19/50

(52) U.S. Cl. CPC G21C 19/307; G21C 1/303; G21C 3/60; G21C 19/40; G21C 19/50

(57) ABSTRACT

A system for nuclear power generation includes an accelerator-driven subcritical reactor that operates using molten-salt fuel. The operation of the reactor can be continuously monitored to ensure subcriticality. The system also includes means for removing volatile radioactive fission products from the molten-salt fuel continuously during the operation of the reactor to maintain an amount of the volatile radioactive fission products in the reactor below a threshold corresponding to a safety limit for accidental release of radioactive materials. The system can be used for highly efficient nuclear power generation while preventing criticality accidents and accidental releases of radioactive isotopes.

### CLAIM OF PRIORITY

The present application claims the benefit of priority under 35 U.S.C. § 119 (e) of U.S. Provisional Patent Application No. 63/516,683, entitled “METHOD AND APPARATUS FOR TRANSMUTATION OF NUCLEAR WASTE”, filed Jul. 31, 2023, which is herein incorporated by reference in its entirety.

### TECHNICAL FIELD

This document relates generally to nuclear power generation and more particularly, but not by way of limitation, to an accelerator-driven subcritical nuclear reactor with continuous removal of fission products for improved safety and efficiency.

### BACKGROUND

Radioactive nuclear waste is produced when operating a nuclear reactor to generate power. Disposal of the nuclear waste can be a hazardous and expensive process. For example, in an existing nuclear power generation system using a molten-salt fueled reactor, used fuel rods containing fission products are removed from the reactor containment and transported to a separate processing facility. This process interrupts the operation of the reactor, is costly, and raises safety, environmental, and proliferation concerns that hinder the development and utilization of nuclear power generation technology.

### SUMMARY

A system for nuclear power generation includes an accelerator-driven subcritical reactor that operates using molten-salt fuel. The operation of the reactor can be continuously monitored to ensure subcriticality. The system also includes means for removing volatile radioactive fission products from the molten-salt fuel continuously during the operation of the reactor to maintain an amount of the volatile radioactive fission products in the reactor below a threshold corresponding to a safety limit for accidental release of radioactive materials. The system can be used for highly efficient nuclear power generation while preventing criticality accidents and accidental releases of radioactive isotopes.

An example of a method for nuclear power generation is provided. The method can include operating an accelerator-driven subcritical reactor using molten-salt fuel, including continuously monitoring the operation of the reactor to ensure subcriticality. The method can further include removing volatile radioactive fission products from the molten-salt fuel continuously during the operation of the reactor to maintain an amount of the volatile radioactive fission products in the reactor below a threshold corresponding to a safety limit for accidental release of radioactive materials.

An example of a system for nuclear power generation is also provided. The system can include an accelerator-driven subcritical nuclear reactor configured to operate using molten-salt fuel and a criticality monitor configured to monitor a criticality of operation of the reactor to ensure subcritical operation of the reactor. The system can further include means for removing volatile radioactive fission products from the molten-salt fuel continuously during the operation of the reactor to maintain an amount of the volatile radioactive fission products in the reactor below a threshold corresponding to a safety limit for accidental release of radioactive materials.

This Summary is an overview of some of the teachings of the present application and not intended to be an exclusive or exhaustive treatment of the present subject matter. Further details about the present subject matter are found in the detailed description and appended claims. Other aspects of the disclosure will be apparent to persons skilled in the art upon reading and understanding the following detailed description and viewing the drawings that form a part thereof, each of which are not to be taken in a limiting sense. The scope of the present disclosure is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIG. 1 illustrates an embodiment of a method for nuclear power generation with subcritical reaction and continuous removal of volatile fission products.

FIG. 2 illustrates an embodiment of a system for nuclear power generation using an accelerator-driven subcritical reactor.

FIG. 3 illustrates an embodiment of a system for continuous removal of fission products from a molten-salt fueled reactor.

FIG. 4 illustrates an embodiment of a separation device for isolating light fission products in a system for continuous removal of fission products, such as the system of FIG. 3.

FIG. 5 illustrates an embodiment of an underground placement of portions of a power generation system using an accelerator-driven subcritical reactor.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized, and that structural, logical and electrical changes may be made without departing from the spirit and scope of the present invention. References to “an”, “one”, or “various” embodiments in this disclosure are not necessarily to the same embodiment, and such references contemplate more than one embodiment. The following detailed description provides examples, and the scope of the present invention is defined by the appended claims and their legal equivalents.

This document discusses, among other things, a system and method for transmuting nuclear waste produced from operating molten-salt (MS) nuclear reactors. Existing commercial reactors have followed the requirement of containing volatile radioisotopes in the reactor. Light water reactors (LWRs) use small uranium ceramic discs in long rods that are enclosed in zircaloy or stainless steel cladding that contain all the fission products (FPs), including the volatile fission products. During the period that the fuel rods are in a reactor (e.g., about 3 years), a large inventory of volatile radioisotopes is accumulated.

The present subject matter includes a process for reducing the inventory of volatile radioisotopes in a reactor to a level below the maximum allowable accidental release per day, such as provided in Title 10 of the Code of Federal Regulations, Part 50 (10 CFR § 50). Such a process eliminates the need for cladding. In various embodiments, volatile radioisotopes can be removed using sparging (e.g., bubbling helium through the molten-salt fuel), spraying, (e.g., forcing the molten-salt fuel through a device such as a nozzle that forms many small streams that break up into droplets with large surface area compared to volume, thereby increasing the evaporation of the volatile radioisotopes), separating actinides by mass or using a liquid metal medium, and/or other techniques. In a system according to the present subject matter, the MS fuel circulates, thereby allowing for removal of fission products from it while the reactor operates. Using subcritical operation with the inventory of the specific volatile radioisotopes reduced to a level below the maximum allowable accidental release per day ensures safety of reactor operation while eliminating the need for spending a very long time (e.g., decades of years) to verify the safety of the reactor (e.g., by the U.S. Nuclear Regulatory Commission). This allows for modifying a reactor design for incremental improvement (e.g., applying Deming's principles, as discussed below) with showing by calculation and online measurement that the reactor is subcritical and does not contain a significant inventory of volatile radioisotopes, rather than a decade-long verification before each alteration of the design. Consequently, the present subject matter can significantly facilitate development and application of reactor technology for safer and more cost-efficient nuclear power generation.

The present subject matter can be applied in a power generation system including an accelerator-driven subcritical reactor. A subcritical reactor is a nuclear fission reactor that produces fission without the need for criticality (k_{eff}<1). Instead of a self-sustaining chain reaction, an accelerator-driven subcritical reactor uses an accelerator to provide neutrons for subcritical operation of the reactor (where the output power is proportional to the beam power, also referred to as an “energy amplifier”). An example of the accelerator-driven subcritical reactor is Mu*STAR (Muons Subcritical Technology Advanced Reactor), which is discussed, for example, in Rolland Johnson et al., “Mu*STAR: A Modular Accelerator-Driven Subcritical Reactor Design”, Proceedings of the 10th Int. Particle Accelerator Conf. (IPAC2019), Melbourne, Australia (May 2019), 3555-3557, which is incorporated herein by reference in its entirety. The accelerator-driven subcritical reactor is enclosed in a reactor containment (also referred to as containment building, containment shell, containment vessel, or the like) that is designed to prevent or limit fission products produced by operation of the reactor from being released into the environment.

The present subject matter can be built on, for example, MU*STAR to provide solutions to problems for which nuclear power plants cost so much to build and to operate. Commercial nuclear reactors have been licensed for construction and operation by the U.S. Nuclear Regulatory Commission based on ensuring that criticality accidents and accidental releases of radioactive isotopes are acceptably unlikely. The process to get these licenses is long and expensive, involving extensive calculations and demonstrations, with explicit requirements on all reactor components that cannot be changed for the several decades that the reactor operates. The present subject matter can be applied to replace such a process by: (1) using accelerator-driven subcritical reactors that never contain a critical mass, and (2) continuously removing volatile fission products from the molten salt reactors so that any accidental releases are insignificant. Mu*STAR nuclear power plants (NPPs), which include upgradable modular accelerators and reactors, can then be continuously improved using Deming's principles of total quality management.

W. Edwards Deming (1900-1993) was an engineer and statistician who is often credited with turning the Japanese economy around after the Second World War by providing his 14 principles (W. E. Deming, Out of The Crisis. Cambridge, MA: MIT Press, 2000, 23-24; see also https://deming.org/explore/fourteen-points/) to companies that became global giants of technology development like Toyota and Sony. Seventy years later we see that new companies like Tesla embrace the same principles as essential to success, especially those based on technology. One of the principles, “Improve constantly and forever the system of production and service, to improve quality and productivity, and thus constantly decrease costs . . . ” is practically impossible to follow in the case of the nuclear energy sector that has a licensing paradigm that effectively prohibits changing anything without going back to the drawing board to redo the fundamental modelling.

In 1984, developers of the design of the Fermilab Tevatron superconducting magnet proton-antiproton collider struggled very hard to find a way to get to a luminosity of 10³⁰ cm-2s-1 using the most optimistic values of cross-sections and efficiencies. However, once they started to operate the equipment during commissioning, they started to see where innovations could be made. Then the improvements kept coming such that the luminosity, which is effectively the power of the microscope, increased over 20 years to increase by a factor of over 350 (35,000%). This allowed the discovery of the top quark, one of the 6 building blocks of matter, in fact the heaviest form of matter, as announced in 2005. After 30 years of Tevatron operation as the world's highest energy “atom-smasher”, it was followed by the Large Hadron Collider at European Council for Nuclear Research where the Higgs boson, the ‘god particle’, was discovered. If the rules for development for the Tevatron had been the same as for nuclear reactors, the improvement would be only about 25% judging by how well reactors are able to be improved. The results were amazing, but in successful organizations, such stories are normal for those that can follow Demings' principle to “improve constantly and forever.” In fact, most modern technology is developed using Deming's 5th Principle. A famous example is Moore's law, which is the observation that the number of transistors on an integrated circuit will double every two years with minimal rise in cost.

Difficulties with conventional nuclear power plants include that they are too expensive to build and to operate. Economy of scale arguments have been used to make the nuclear power plant designs larger, to reduce the licensing, operations and support personnel, and general infrastructure costs per gigawatt hour (GWh). A nuclear power plant based on smaller replaceable factory-built modules that operate subcritically with online fission product removal, designed according to the present subject matter, can allow Deming's “improve constantly . . . ” principle to be followed to substantially lower the cost of nuclear energy.

The need for nuclear energy has become increasingly obvious as the misperceptions of the safety of nuclear energy are explicitly confronted and the benefits for climate change are made clear. For example, statistics showed that nuclear energy was associated with a death rate from accidents and air pollution that was lower than coal, oil, natural gas, biomass, hydropower, and wind (and only slightly higher than solar energy) and also showed that nuclear energy was associated with greenhouse gas (GHG) emissions that was lower than coal, oil, natural gas, biomass, hydropower, wind, and solar energy (H. Ritchie, “What are the safest and cleanest sources of energy?” https://ourworldindata.org/safest-sources-of-energy, 2020). Projections for new reactors to be built in the world by year 2050 are uncertain since there are many variables and even the goals are not clearly defined. However, it is likely that over 200 gigawatts (GW) of new nuclear capacity will be needed to stabilize the global temperature increase.

There is sufficient time to make tremendous advances in the technology of nuclear reactors if the development paradigm forced on the nuclear energy industry by strict regulations is changed, for example by applying the present subject matter as discussed herein. Starting with a relatively small modular reactor driven by a modular proton accelerator and an enthused team of physicists, chemists, and engineers, the development of rapidly deployed, subcritical reactors may proceed in good time according to Deming's principles.

Title 10 of the Code of Federal Regulations defines a nuclear reactor as “any apparatus or device in which a nuclear chain reaction can be sustained and controlled in a self-supporting or neutron multiplying medium, and which is designed or used to produce heat, power, or any other form of radiation.” Appendix A to 10 CFR § 50 provides that nuclear power plants must limit the release of radioactive materials into the environment following an accident. The limit for the release of iodine-131 is 5 curies per day. The limit for the release of cesium-137 is 15 curies per day. Online monitoring of criticality and internal isotope inventory adds robustness to the concept.

In the current regulatory scheme, decades are required to certify reactor designs and components. The regulatory process is time-consuming and expensive. This is driven by the current regulatory demands to prevent (1) criticality accidents and (2) accidental releases of radioactive isotopes. These two demands have practically created a paralyzing model for technology innovation, as seen by the licensing requirements of nuclear power plants. Designs are cast in concrete with little ability to accommodate technological breakthroughs and innovations. Operation of a nuclear plant is expected to follow the same procedures for the succeeding 4-8 decades. Then the whole reactor has to be decommissioned and the spent nuclear fuel (SNF, also known as used nuclear fuel, or UNF) put into a geologic repository.

The present subject matter can be applied to satisfy these two demands, with an accelerator-driven subcritical reactor and molten-salt fuel with continuous removal of volatile radioactive isotopes. The criticality accidents are avoided because there is not a critical mass in the reactor. The accidental releases of radioactive isotopes are also avoided because volatile isotopes in the core are less than a safe amount (e.g., as allowed by regulations for accidental releases per day). If needed, an additional defense in depth approach by including a containment vessel can be part of the requirement.

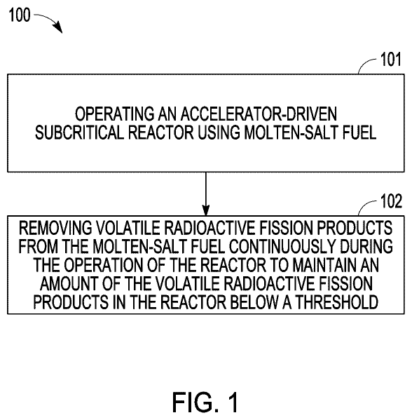

FIG. 1 illustrates an embodiment of a method 100 for nuclear power generation with subcritical reaction and continuous removal of volatile fission products. The subcritical reaction can be applied to prevent criticality accidents. The continuous removal of volatile fission products can be applied to prevent accidental releases of radioactive isotopes.

At 101, an accelerator-driven subcritical reactor is operated using molten-salt fuel. The operation can be continuously monitored to ensure subcriticality (i.e., the fissionable materials in the reactor does not reach the critical mass). The critical mass is the minimum amount of fissionable material (e.g., uranium) required to support a self-sustaining chain reaction. The monitoring is performed to prevent criticality accidents, which are unintentional, uncontrolled nuclear fission reactions.

In various embodiments, the criticality of the operation can be continuously monitored by measuring the rate of neutron production in the molten-salt fuel in the reactor as a function of time after a pulse of neutrons is produced in the reactor by a proton bunch from the accelerator. If the rate of neutron production is constant, the reactor is in critical operation (k_{eff}=1). If the rate of neutron production falls with time, the reactor is in subcritical operation (k_{eff}<1). If the rate of neutron production rises with time, the reactor is in supercritical operation (k_{eff}>1). Thus, the rate of rate of neutron production can be used as a direct measure of the criticality of the reactor.

At 102, volatile radioactive fission products are continuously removed from the molten-salt fuel during the operation of the reactor to maintain an amount of the volatile radioactive fission products in the reactor below a threshold corresponding to a safety limit for accidental release of radioactive materials. The continuous removal of the radioactive fission products ensures that in case of an accident, the worse case amount of release of radioactive materials cannot exceed the safely limit. This prevents accidental releases of radioactive isotopes defined as release of radioactive isotopes in an amount exceeding the safety limit. The safety limit can include government regulatory requirements (e.g., as specified in Appendix A to 10 CFR § 50 in the U.S.).

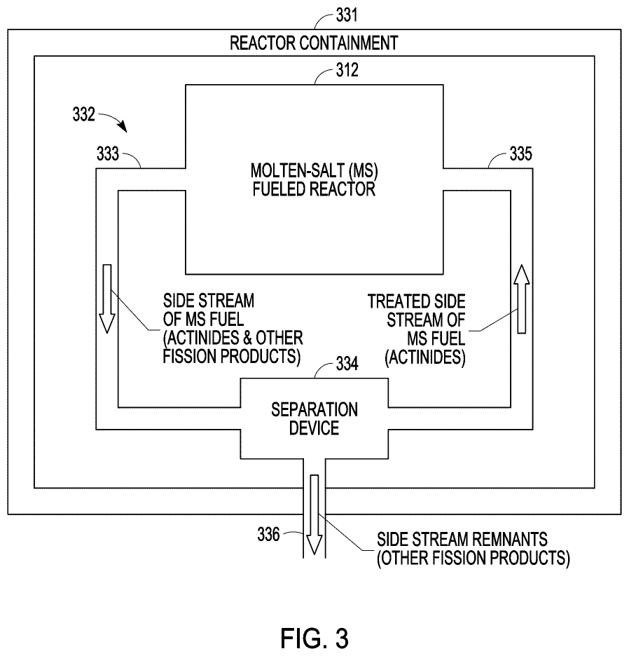

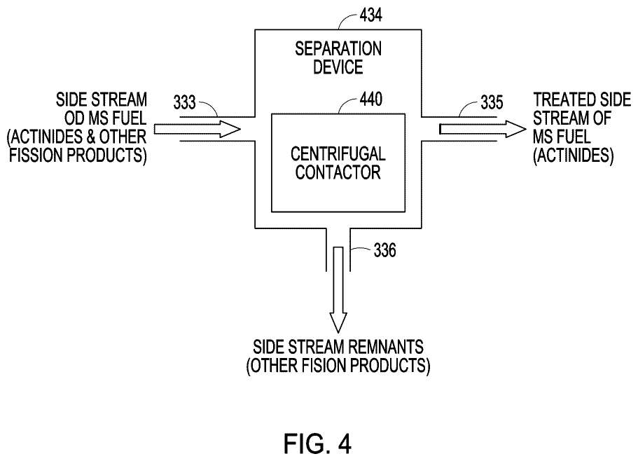

In various embodiments, volatile fission products, including volatile radioisotopes, can be removed using any one or any combination of:
sparging, as known in chemistry and also known as gas flushing in metallurgy, which is a technique in which a gas is bubbled through a liquid in order to remove other dissolved gas(es) and/or dissolved volatile liquid(s) from that liquid, thus a method of degassing (e.g., bubbling helium through the molten salt fuel);
spraying, described in paragraph was used in the Oak Ridge National Laboratory (ORNL) Molten-Salt Reactor Experiment (MSRE) (e.g., as discussed in Taylor et al., “Mu*STAR ADSR Fuel Conversion Facility Evaluation and Cost Analysis,” ORNL/TM-2018/989, Oak Ridge National Laboratory, 2019, 5);
separating actinides by mass or using a liquid metal medium, as discussed below with reference to FIGS. 3 and 4; and
other techniques (e.g., letting a thin layer of molten-salt liquid flow over a heated flat plate to increase the evaporation rate of gases from the molten-salt fuel).

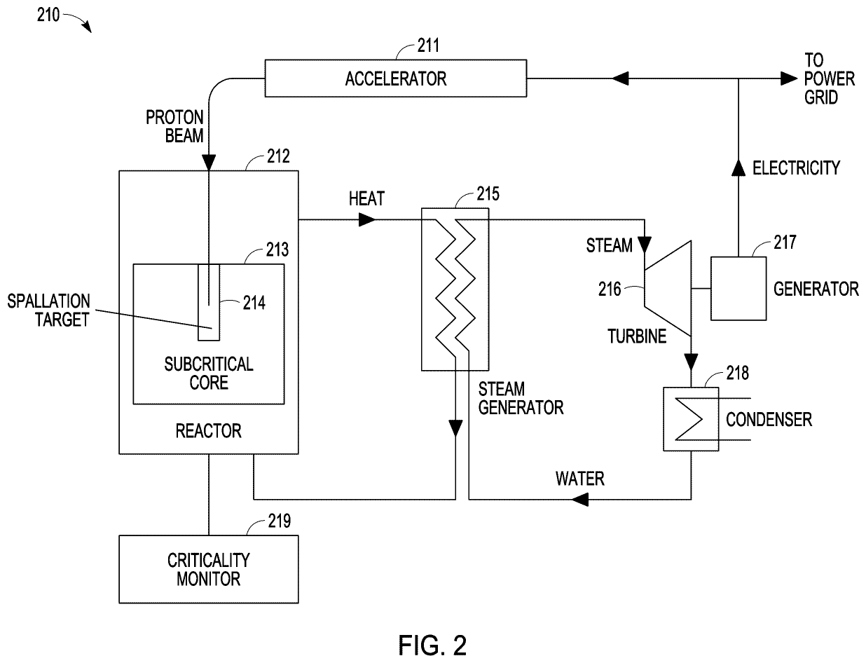

In various embodiments, the accelerator-driven subcritical reactor is housed in a reactor containment, and the process of continuously removing the radioactive fission products from the molten-salt fuel is performed within the reactor containment until the resulting substances can be safely disposed. The operation of the reactor and the removal of the radioactive fission products can be performed using, for example, the systems discussed below, with references to FIGS. 2-5. Systems as shown in FIGS. 2-5 are represented for illustrative, but not restrictive, purposes of discussing how method 100 can be applied in nuclear power generation.

FIG. 2 illustrates an embodiment of a system 210 for nuclear power generation using an accelerator-driven subcritical reactor. System 210 can include an accelerator 211, a reactor 212, a steam generator 215, a turbine 216, a generator 217, a condenser 218, and a criticality monitor 219.

Accelerator 211 can generate a proton beam to be injected into reactor 212. In one embodiment, accelerator 211 is a superconducting linear particle accelerator (linac). Reactor 212 can include a subcritical core 213 and a spallation target 214 in subcritical core 213. In one embodiment, reactor 212 is a small modular reactor that can be manufactured in one or more factories and transported to the site of operation (e.g., a nuclear power plant). Spallation target 214 can include a heavy metal target, e.g., a uranium target. The proton beam generated by accelerator 211 can be guided to strike on spallation target 214 to cause each nucleus to produce multiple (e.g., about 30) neutrons for each proton in the proton beam. The criticality depends on materials and geometry, but not on the neutrons created by the beam. Each proton injected into reactor 212 can create a chain reaction that creates heat while dying out (i.e., not self-sustaining). The use of the superconducting linac 211 thus allows reactor 212 to operate below criticality and not to be capable of self-sustained operation (and hence not a “reactor” under certain definitions such as regulatory definitions). In various embodiments, a single accelerator 211 is capable of driving multiple instances of reactor 212 (e.g., multiple small modular reactors, such as up to 10 small modular reactors).

Steam generator 215 can receive thermal energy from reactor 212, receive water, and produce steam by heating the received water using the received thermal energy. Turbine 216 can receive the steam and produce a revolving motion using the flow of the steam. Generator 217 can generate electricity by converting mechanical energy of the revolving motion into electrical energy. A portion of the generated electricity can be applied to maintain operation of accelerator 211, while the remainder of the generated electricity can be delivered to a power grid. Condenser 218 can cool the steam into water after the steam has passed through turbine 216. The water produced by condenser 218 can then circulate back to steam generator 215 for further steam generation.

Criticality monitor 219 can monitor the criticality of operation of reactor 212 to ensure subcritical operation of reactor 212, for which the amount of fissionable material (e.g., uranium) in reactor 212 is below the critical mass for self-sustainable reaction. In various embodiments, criticality monitor 219 can measure the rate of neutron production in the molten-salt fuel as a function of time during a measurement period of time after a pulse of neutrons is produced in reactor 212 by a proton bunch of the proton beam injected into reactor 212 from accelerator 211. The measurement can performed frequently during the operation of reactor 212, for example following the injection of each proton bunch, to allow for continuous monitoring of the criticality during operation of reactor 212. If the rate of neutron production measured during the measurement period is constant, reactor 212 is in critical operation (k_{eff}=1). If the rate of neutron production measured during the measurement period falls with time, reactor 212 is in subcritical operation (k_{eff}<1). If the rate of neutron production measured during the measurement period rises with time, reactor 212 is in supercritical operation (k_{eff}>1).

FIG. 3 illustrates an embodiment of a system 332 for continuous removal of fission products from a molten-salt fueled reactor 312 enclosed in a reactor containment 331. Reactor 312 can be an example of reactor 212 and can be a an accelerator-driven subcritical reactor. System 332 can include a side stream conduit 333 coupled to reactor 312 and positioned within reactor containment 331, a separation device 334 coupled to conduit 333 and positioned within reactor containment 331, a treated side stream conduit 335 coupled between separation device 334 and reactor 312 and positioned within reactor containment 331, and a fission product conduit 336 coupled to separation device 334. Conduit 333 can receive a side stream of a molten-salt fuel flowing out of reactor 312 while reactor 312 is operating. The received side stream includes and other fission products. Separation device 334 can receive the side stream from conduit 333 and treat the received side stream to separate heavy fission products (e.g., actinides) and light fission products (e.g., fission products in the side stream other than the actinides). The light fission products include the other fission products without the actinides. Conduit 335 can feed the treated side stream including the actinides back into reactor 312 for thermal energy generation (and ultimately electric power generation) and destruction of the actinides in reactor 312. Fission product conduit 336 allows for removal of the light fission products (as referred to as side stream remnants) from reactor containment 331 while reactor 312 is operating. An example of system 332 is discussed in U.S. Patent Application Publication No. 2023/0154636 A1, “CONTINUOUS REMOVAL OF FISSION PRODUCTS FROM MOLTEN-SALT FUELED REACTORS”, which is incorporated herein by reference in its entirety.

FIG. 4 illustrates an embodiment of a separation device 434 for isolating light fission products in a system for continuous removal of fission products, such as system 332. Separation device 434 can be an example of separation device 334. In the illustrated embodiment, separation device 434 includes a centrifugal contactor (also known as centrifugal separator, centrifugal extractor, or annular centrifugal contactor) 440. Centrifugal contactor 440 is a mass separation device that can isolate the light fission products from the side stream by mass using centrifugation. Separation device 434 can also include a vortex separator and a Tesla-valve based separator (a modified Tesla valve). In one embodiment, separation device 434 includes a liquid-metal separation device that introduces a molten metal into the received side stream. The light fission products in the received side stream migrate to a contactor containing the liquid-metal. The liquid metal reduces actinides and other fission products that are separable by established chemical methods. The actinide fraction is transferred to a carrier molten fuel for reinjection into the reactor. The actinides are never separated from the molten-salt carrier, which is advantage in preventing weapons proliferation. The metal containing the light fission products can be cleaned and reused by removing the light fission products. The light fission products are removed from the side stream. In various embodiments, separation device 434 can perform any method of separation discussed in this document or otherwise known by those skilled in the art. In various embodiments, separation device 434 can produce the light fission products having a radiotoxicity lifetime for which a geological repository is not required. The separation of the actinides and the light fission products as performed by separation device 434 can be performed within a reactor containment (e.g., containment 331) without interrupting the operation of the reactor (e.g., reactor 312), allowing for safe, continuous removal of the fission products without the need of a separate plant. In various embodiments, separation device 434 can produce the fission products having a radiotoxicity lifetime for which a geological repository is not required.

In various embodiments, side stream extraction of fission products from the molten-salt fuel, as discussed above with reference to FIGS. 3 and 4, can allow the actinides to remain in the fuel while many neutron poisons are continuously removed. The feasibility has been demonstrated by continuously removing atoms that uranium and plutonium split into from an operating reactor core (e.g., the MSRE). In addition to reducing the risk of accidental radioisotope releases from the subcritical core, removing fission products can include removing neutron poisons, which allow for very high burnup of the molten-salt fuel.

In various embodiments, system 210 can be implemented using Mu*STAR, which is an accelerator driven molten-salt reactor with an internal spallation target and continuous removal of fission products to consume spent nuclear fuel from past, present, and future reactors. A Mu*STAR nuclear power plant uses a superconducting (SC) proton accelerator, derived from the technology of the ORNL spallation neutron source (SNS) linac, to drive several subcritical small modular reactors (SMRs). Each small modular reactor is a graphite moderated molten-salt fueled reactor, such as the one studied in the Molten Salt Reactor Experiment (MSRE) (P. N. Haubenreich and J. R. Engel, “Experience with the Molten-Salt Reactor Experiment,” Nuclear Applications & Technology, Vol. 8, February 1970, 118-136), but with an internal spallation target to generate source neutrons. These source neutrons initiate fission chains that die out, producing energy in the subcritical core. The molten salt core remains below criticality (which depends on materials and geometry but not the beam), is always incapable of self-generated operation, and is immune to criticality accidents. The molten-salt fuel in the core is continuously purged of volatile fission products such that the offsite doses associated with the core volatile source term can be reduced by orders of magnitude. The combination of subcriticality and the small source term can deliver deployment flexibility and regulatory simplification to enable the nuclear energy generation to have a real impact on greenhouse gas emissions.

A 2 gigawatt-electric (GWe) nuclear power plant is being developed to contribute to reaching the zero carbon goals of many states in the U.S. in the next two decades based on subcritical power generation. Up to 10 Mu*STAR modules would share a common accelerator source. Reliability of the single factory-built linac is addressed by its modularity, internal redundancy, and an intermediate thermal energy storage system to cover downtimes for module repairs or replacement. The levelized cost of electricity is reduced by staged next-of-a-kind small modular reactor factory construction and secure underground economy-of-scale-operation.

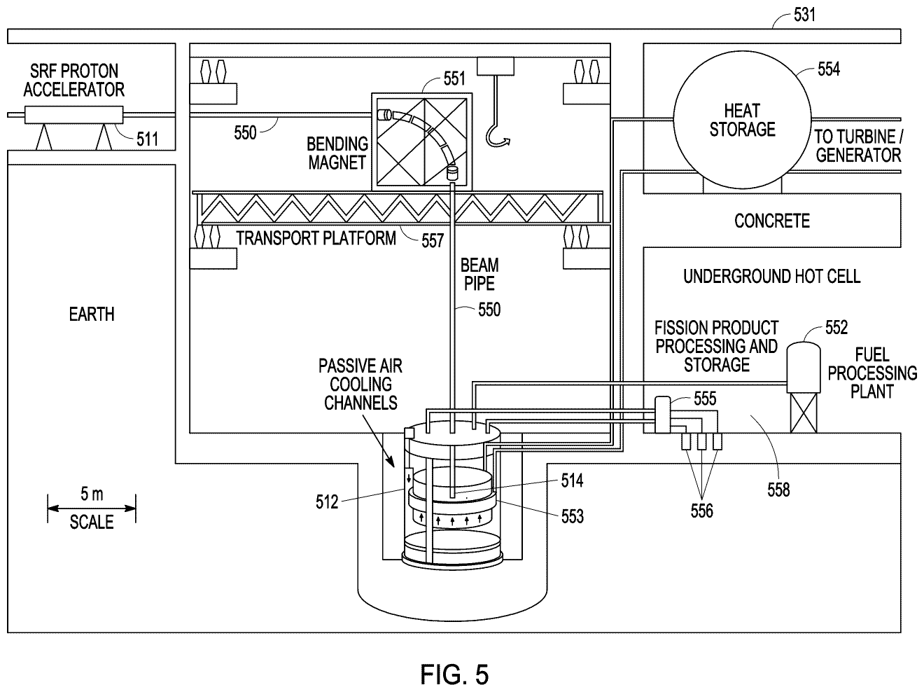

The first Mu*STAR nuclear power plant may start with a single superconducting linac driving a single factory-built small modular reactor as a pilot plant on the site of an existing nuclear installation. With operational experience, small modular reactor modules may be added along with linac upgrades to split the beam to each small modular reactor, on a radio-frequency (RF) bunch-by-bunch basis. This accelerator-driven, high-temperature Mu*STAR nuclear power plant design can be deployed for diverse missions including electric generation, used fuel disposition, process heat generation, hydrogen production, tritium production in support of future fusion systems, or any combination of these. The initial pilot plant is a natural place to develop these various applications and explore upgrade paths for subsequent plants. The spent nuclear fuel can be converted from oxides to fluorides as used by the MSRE and Mu*STAR. A conceptual example of a Mu*STAR system placed on location of an existing light water reactor (LWR) site is discussed below with reference to FIG. 5. The system includes a hot cell for conversion of stored spent fuel rods into fluoride salts.

FIG. 5 illustrates an embodiment of an underground placement of portions of a power generation system using an accelerator-driven subcritical reactor. The portions of the system as shown in FIG. 5 are enclosed in a reactor containment 531 (e.g., a concrete containment). Components of the system as shown in FIG. 5 include a superconducting radio-frequency (SRF) proton accelerator 511, a reactor 512 including an internal spallation target 514 and a heat exchanger 553, beam pipes 550, a bending magnet 551, a transport platform 557, a heat storage 554, a hot cell 558 enclosing a fission product processing unit 555, a processed fission product storage 556, and a fuel processing plant 552. In various embodiments, these components can be manufactured in one or more factories and installed in the light water reactor site. The 5-meter (5 m) scale is shown in FIG. 5 to provide a general illustration of dimensions of the power generation system by way of example, but not by way of restriction.

SRF proton accelerator 511 can be an example of accelerator 211. Reactor 512 can be a small modular reactor, such as an example of reactor 212 or 312. SRF proton accelerator 511 can generate a proton beam, which is guided through beam pipes 550 and bending magnet 551 to be injected into reactor 512 to strike internal spallation target 514, which can be a heavy metal, such as uranium, target. Heat exchanger 553 can receive thermal energy resulting from the reaction in reactor 512 to be transmitted to heat storage 554, which is an intermediate heart storage between reactor 512 and the turbine-generator that converts the thermal energy to electrical energy. Transport platform 557 can move the bending magnet and beam pipes out of way for maintenance of reactor 512. Hot cell 558 includes the system components for converting spent nuclear fuel oxide to fluoride and fission product removal and for preparing the fuel. Fission product processing unit 555 can include a separation device such as separation device 334 or 434 that can isolate light fission products from a side stream of molten-salt fuel flowing out of reactor 512. Fission product processing unit 555 can also include a fractional distillation column for extracting useful isotope products from the isolated light fission products. As shown in FIG. 5, fission product processing unit 555 can receive the side stream of molten-salt fuel from reactor 512 through a helium purge and volatile fission products pipe and returns a processed (i.e., treated) fuel stream including actinides to reactor 512 through a helium returning pipe. Processed fission product storage 556 can include multiple storage devices for storing isotope products produced by fission product processing unit 555 and waste extracted by fission product processing unit 555 to be removed from containment 531. Fuel processing plant 552 can prepare the molten-salt fuel to be transmitted to reactor 512 through a fuel pipe.

Examples of various challenges to existing light water reactors and critical reactors include: (1) waste: less than 5% of the energy content of the fuel is utilized in a conventional light water reactor; (2) radiotoxicity: plutonium and other elements produced during use of the have long time to decay and make the waste radiotoxic for about 100,000 years; (3) proliferation: the nuclear waste is a weapons proliferation and terrorist treat and must be secured and guarded at $15/kg (more than 1 billion U.S. dollars per year); and (4) lack of acceptable solution to the problem of light water reactor waste in the U.S.

The present subject matter can be applied to address such challenges by consuming waste spent nuclear fuel for safe and affordable nuclear energy. The reactor such as the Mu*STAR can consume remaining energy in spent nuclear fuel, thereby consuming at least 10 times more energy-efficient than a conventional light water reactor. No uranium enrichment, no plutonium separation, and no spend nuclear fuel processing is involved in operating the power generation system according to the present subject matter. The fuel can be converted and used, and the remnants can be permanently buried on site. The power generation system according to the present subject matter is not subjected to the regulatory requirements that practically prohibit continuous improvement (thereby allowing application of Deming's principles), requires fewer safeguarding expenses, and produces valuable byproducts.

In summary, features of a nuclear power plant constructed and operating according to the present subject matter (e.g., based on Mu*STAR) can include, but are not limited to:
Nuclear power plant developed using Deming's principles:
   Subcritical reaction to prevent criticality accidents; and
   Accidental radioactive releases-mitigated by sparging, spraying, and side stream removal;
Decoupling of nuclear energy from nuclear weapons:
   No uranium enrichment is needed;
   No dedicated reprocessing facility with plutonium stream is needed; and
   Fissile uranium and plutonium are consumed in the reactor;
Inexpensive nuclear energy with high burnup of spent nuclear fuel;
Online neutron poison removal, which improves efficiency;
Consumption of spent nuclear fuel to enable other reactors, making spend nuclear fuel a valuable commodity; and
Allowing spent nuclear fuel stored in many sites in the U.S. to be converted and consumed onsite, thereby providing energy security for many decades.

Profitability in solving the legacy challenge of nuclear waste in existing light water reactors can include, but are not limited to:
Radiotoxic lifetime shortened to 0.003 times: reduction in radiotoxic lifetime of nuclear waste from 100,000 years to 300 years, and hence savings in waste storage, treatment, and disposal;
Thirteen trillion U.S. dollars ($13,000,000,000,000) worth of asset turned from waste: the current unwanted 90 kiloton (kT) of nuclear waste in the U.S. alone can be used to produce carbon-free electrical energy worth trillions of dollars;
Ample resource for 1,000 years: enough amount of uranium has already been mined to supply 100% of the U.S. electricity needs for 1,000 years without reprocessing and without further enrichment; and
Carbon credits of $12.70/ton of CO₂ in the U.S.: from voluntary and legislated carbon credits for carbon-free generated energy (e.g., the Inflation Reduction Act proposes a $25 carbon tax credit for each megawatt hour (MWh) of carbon-free energy produced, which allows a 2-GWe plant to produce $438 million per year carbon tax credits).

The present subject matter can be applied to a power generation system that uses a nuclear reactor such as an accelerator-driven subcritical modular molten-salt fueled reactor to consume spent nuclear fuel. In various embodiments, the present system can have, for example, some or all of the following characteristics:
All of the 95% of energy remaining in the spent nuclear fuel can be used, while all the actinides in the spent nuclear fuel are consumed and/or destroyed, by increasing the accelerator power and/or removing neutron poison fission products.
After useful elements are extracted from the spent nuclear fuel, the ash to be buried has radiotoxicity similar to medical waste, allowing local burial. This is because long lived actinides are destroyed by keeping them in the reactor.
The large amount of spent nuclear fuel in U.S., especially with high burnup, provides extraordinary energy security.
The present subject matter can be implemented using the superconducting linac of the ORNL Spallation Neutron Source upgraded from 6% duty factor to continuous wave operation and using the ORNL Molten Salt Reactor Experiment upgraded to have an internal solid uranium spallation target, with magnetron power sources that are more efficient such that 100% duty factor will be possible for a superconducting linac.
No reprocessing is involved, with the oxides in the spent nuclear fuel being converted to fluorides. The usual meaning of reprocessing is to separate the components of the spent nuclear fuel and to reconstitute them in a new fuel form like mixed oxide fuel (MOX) where plutonium-239 and uranium-238 oxides are combined to make new fuel rod assemblies. The nuclear weapons proliferation concern of reprocessing is that there will be a time in the process where a pure stream of plutonium-239 will be available to be stolen to make a nuclear weapon.
The spent nuclear fuel contains enough fissile material that no enriched uranium is required. When it is removed from operating in a light water reactor, the fuel rod is producing about 30% of its energy from fissioning plutonium-239 which was transmuted from the uranium-238. The remaining uranium-235 and plutonium-239 in the spent nuclear fuel that are not consumed in the light water reactor are enough to start the generation of energy from a reactor such as the Mu*STAR.
The virtue of the molten-salt fuel is that it can be circulated in a side stream within the reactor confinement volume to allow fission products to be continuously removed from the fuel.
Actinides remain in the fuel until they are consumed;
Removing neutron poison FPs from the fuel means that deeper burns are allowed; and
Removing volatile radioisotopes reduces their inventory in the core to mitigate accidental releases.

It is to be understood that the above detailed description is intended to be illustrative, and not restrictive. Other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method for nuclear power generation, comprising:
operating an accelerator-driven subcritical reactor using molten-salt fuel, including continuously monitoring the operation of the reactor to ensure subcriticality; and
removing volatile radioactive fission products from the molten-salt fuel continuously during the operation of the reactor to maintain an amount of the volatile radioactive fission products in the reactor below a threshold corresponding to a safety limit for accidental release of radioactive materials.

2. The method of claim 1, wherein the safety limit is required by a government regulation.

3. The method of claim 1, wherein operating the accelerator-driven subcritical reactor comprises operating a superconducting linear particle accelerator and a small modular reactor, the superconducting linear particle accelerator configured to generate a proton beam to be injected into the small modular reactor, the small modular reactor including a subcritical core and a spallation target positioned in a subcritical core.

4. The method of claim 3, wherein continuously monitoring the operation of the reactor comprises measuring a rate of neutron production in the reactor as a function of time during a measurement period after a pulse of neutrons is produced in the reactor by a proton bunch of the proton beam.

5. The method of claim 3, further comprising manufacturing the small modular reactor in one or more factories remote from a site of the nuclear power generation.

6. The method of claim 3, further comprising providing a uranium target to be the spallation target.

7. The method of claim 3, further comprising operating one or more additional small modular reactors with the superconducting linear particle accelerator being used to drive the small modular reactor and the one or more additional small modular reactors.

8. The method of claim 3, further comprising housing the accelerator-driven subcritical reactor in a reactor containment.

9. The method of claim 8, wherein removing volatile radioactive fission products comprises:
producing a side stream of the molten-salt fuel flowing out of the reactor, the side stream including light fission products and actinides;
separating the light fission products from the actinides; and
returning the actinides to the reactor,
wherein the receiving, separating, and returning are performed within the reactor containment while the reactor is operating.

10. The method of claim 9, wherein returning the actinides to the reactor comprises:
leaving the actinides in the side stream; and
injecting the side stream including the actinides back to the reactor for transmutation of a portion of the actinides and destruction of the remaining portion of the actinides.

11. The method of claim 9, wherein separating the light fission products from the actinides comprises isolating the light fission products from the side stream using at least one of a contactor or a vortex separator.

12. The method of claim 11, wherein isolating the light fission products from the side stream comprises isolating the light fission products from the side stream by mass using centrifugation.

13. The method of claim 11, wherein isolating the light fission products from the side stream comprises:
introducing into the side stream a molten metal to which the light fission products migrate;
separating the molten metal with the light fission products from the side stream; and
purging the light fission products from the molten metal.

14. The method of claim 11, further comprising removing the isolated light fission products from the reactor containment, the removed light fission products having a radiotoxicity lifetime for which a geological repository is not required.

15. The method of claim 11, further comprising extracting one or more isotopes from the isolated light fission products using fractional distillation.

16. A system for nuclear power generation, comprising:
an accelerator-driven subcritical nuclear reactor configured to operate using molten-salt fuel;
a criticality monitor configured to monitor a criticality of operation of the reactor to ensure subcritical operation of the reactor; and
means for removing volatile radioactive fission products from the molten-salt fuel continuously during the operation of the reactor to maintain an amount of the volatile radioactive fission products in the reactor below a threshold corresponding to a safety limit for accidental release of radioactive materials.

17. The system of claim 16, wherein the accelerator-driven subcritical nuclear reactor comprises a small modular reactor including a subcritical core and a spallation target positioned in the subcritical core, and further comprising a superconducting linear particle accelerator configured to generate a proton beam to be injected into the small modular reactor to strike the spallation target.

18. The system of claim 17, further comprising a reactor containment housing the small modular reactor and the means for removing the volatile radioactive fission products, and wherein the means for removing the volatile radioactive fission products comprises
a first fuel conduit coupled to the small modular reactor and positioned within the reactor containment, the first fuel conduit configured to receive a side stream of a molten-salt fuel including actinides and light fission products flowing out of the small modular reactor while the small modular reactor is operating;
a separation device coupled to the first fuel conduit and positioned within the reactor containment, the separation device configured to receive the side stream and to treat the received side stream to isolate the light fission products;
a second fuel conduit coupled between the separation device and the small modular reactor and positioned within the reactor containment, the second fuel conduit configured to feed the treated side stream including the actinides back into the small modular reactor for power generation and destruction of the actinides in the reactor; and
a fission product conduit coupled to the separation device, the fission product conduit configured to allow for removal of the light fission products from the reactor containment while the small modular reactor is operating, the light fission products to be removed having a radiotoxicity lifetime for which a geological repository is not required.

19. The system of claim 18, wherein the separation device comprises at least one of a contactor or a vortex separator.

20. The system of claim 17, further comprising one or more additional small modular reactors each including a subcritical core and a spallation target positioned in the subcritical core, and wherein the superconducting linear particle accelerator is configured to generate a proton beam to be injected into each small modular reactor of the small modular reactor and the additional one or more small modular reactor to strike the spallation target of that small modular reactor.
